(19) United States
(12) Patent Application Publication
(10) Pub. No.: US 2019/0030782 A1
(43) Pub. Date: Jan. 31, 2019

(54) SEQUENTIAL PRESS AND CO-MOLD SYSTEM

(71) Applicant: Bio-Rad Laboratories, Inc., Hercules, CA (US)

(72) Inventors: Clayton T. McKEE, Davis, CA (US); William STRONG, El Cerrito, CA (US)

(21) Appl. No.: 16/042,672

(22) Filed: Jul. 23, 2018

Related U.S. Application Data
(60) Provisional application No. 62/537,730, filed on Jul. 27, 2017.

(51) Int. Cl. B29C 51/36; B29C 51/10; B29C 51/00; B29C 51/42

(52) U.S. Cl. CPC B29C 51/365; B29C 51/10; B29K 2001/08; B29C 51/421; B29C 2791/006; B29C 51/002

(57) ABSTRACT

Molding systems and methods of using such systems are provided.

### CROSS-REFERENCES TO RELATED APPLICATIONS

This application claims the benefit of U.S. Provisional Application 62/537,730 filed on Jul. 27, 2017, which is hereby incorporated by reference in its entirety.

### BACKGROUND

Vacuum forming a material comprises heating a sheet of material such as plastic to a forming temperature, stretching the material onto a single-surface mold, and forcing the material against the mold by a vacuum. However, vacuum forming cannot be used for molding a non-stretchable sheet of material because the material can tear or break.

### SUMMARY

Provided herein are sequential press and co-mold systems and methods of using such systems.

In an embodiment, a molding system comprises a mold having a first end, a second end and two lateral sides, the mold comprising a plurality of depressions on about a first half of the mold; a planar region on about a second half of the mold; and a plurality of through-holes for applying a vacuum to the mold, the through-holes running from an upper surface to a lower surface of the mold; a frame having a plurality of vertically movable presses; and a vacuum source operatively connected to each of the through-holes in the mold.

In certain embodiments, each press sequentially fits into a different depression in the mold. In some embodiments, a first press rests on a ridge of the mold and each subsequent press sequentially fits into a different depression in the mold. In some embodiments, each of the depressions has a longest dimension perpendicular to a lateral side of the mold. In certain embodiments, each press has a width spanning the longest dimension of each of the depressions in the mold. In some embodiments, the distance of each press from the mold increases from a first end of the frame to a second end of the frame. In some embodiments, each press is operable by gravity. In some embodiments, each press is motor driven. In certain embodiments, the plurality of depressions is at least two depressions. In some embodiments, the system further comprising a second vacuum source.

In an embodiment, a method of co-molding and thermobonding a first sheet to a second sheet comprises sequentially press-fitting the first sheet onto a mold to form a shaped first sheet, wherein the mold comprises a plurality of through-holes for applying a vacuum to the mold;

applying a vacuum to the mold to hold the shaped first sheet to the mold; applying a second sheet heated to a molding and bonding temperature to the shaped first sheet; pulling the heated second sheet tight to the shaped first sheet with the vacuum to co-mold and thermobond the second sheet to the shaped first sheet. In certain embodiments, the first sheet is sequentially press-fitted into a plurality of depressions in the mold. In some embodiments, the method further comprises anchoring the first sheet onto the mold prior to sequentially press-fitting the first sheet onto the mold. In some embodiments, a surface area of the first sheet is not capable of increasing or decreasing. In some embodiments, the first sheet is porous. In some embodiments, a surface area of the second sheet is capable of increasing or decreasing. In certain embodiments, the second sheet is not porous. In some embodiments, the surface area of the second sheet is increased by heating the second sheet. In some embodiments, the molding and bonding temperature is at least a glass transition temperature. In certain embodiments, the heated second sheet is applied to the shaped first sheet simultaneous with pulling the heated second sheet tight to the shaped first sheet.

In some embodiments, a method of co-molding and thermobonding a first sheet to a second sheet comprises sequentially applying a vacuum to the first sheet to sequentially pull the first sheet tight to a mold to form a shaped first sheet, wherein the mold comprises a plurality of through-holes for applying a vacuum to the mold; applying a second sheet heated to a molding and bonding temperature to the shaped first sheet; pulling the heated second sheet tight to the shaped first sheet with the vacuum to co-mold and thermobond the second sheet to the shaped first sheet. In some embodiments, the sequentially applying a vacuum to the first sheet step comprises sequentially pulling the first sheet into a plurality of depressions in the mold. In certain embodiments, the vacuum is applied sequentially to the first sheet by sequentially uncovering the through-holes in the mold.

In some embodiments, the shaped first sheet comprises a plurality of depressions. In some embodiments, the plurality of depressions is on about a first half of the shaped first sheet. In some embodiments, each of the depressions has a longest dimension perpendicular to a lateral edge of the shaped first sheet. In some embodiments, a cross-section of each of the depressions has a shape selected from the group consisting of a v, a semicircle, an oval, a u, a rectangle, a square, and a trapezoid. In some embodiments, the plurality of depressions is at least two depressions. In certain embodiments, the first sheet is formed of at least one material selected from the group consisting of glass fiber, cellulose, and polymeric material. In some embodiments, the second sheet is formed of a thermoplastic. In some embodiments, the thermoplastic is selected from the group consisting of polyethylene terephthalate, polyethylene terephthalate glycol modified, polypropylene, polystyrene, and polycarbonate.

### BRIEF DESCRIPTION OF THE DRAWINGS

FIGS. 1A-1D are schematic perspective side views of a molding system in various stages of operation according to an embodiment of the invention. The system is shown without a sheet of material being pressed into the depressions in the mold.

FIGS. 2A-2D are schematic perspective side views of a frame of the molding system shown in FIG. 1 in which the frame is holding one or more movable presses.

FIGS. 3A-3E are schematic side views of various stages of a method of co-molding and thermobonding a first and second sheet according to an embodiment of the invention. For clarity, only the mold and the sheets are shown.

FIGS. 4A-4E are schematic side views of various stages of a method of co-molding and thermobonding a first and second sheet according to an embodiment of the invention. Vacuum is sequentially applied to the mold to sequentially pull the first sheet tight to the mold to shape the first sheet.

### DETAILED DESCRIPTION

Described herein are systems and methods for co-molding and thermobonding a first sheet to a second sheet. Systems and methods of using such systems have been discovered that sequentially mold and bond two sheets of different material without the use of adhesive. The resultant molded and bonded sheets of material can be used, for example, in a lateral flow device for detecting analytes (e.g., proteins, nucleic acids) immobilized on a substrate (e.g., a western blotting membrane). An example of such a lateral flow device is described in co-pending U.S. Provisional Patent Application 62/425,839 filed on Nov. 23, 2016 which is incorporated by reference in its entirety herein.

### I. DEFINITIONS

The term “sheet” refers to a portion of material that is thin in comparison to its length or breadth. In some embodiments, either the length or width of the sheet is at least 10× larger than the height. Examples of a sheet include, but are not limited to, a film, a surface, a roll of material, and a flat or planar piece of material.

As used in this specification and the appended claims, the singular forms “a”, “an”, and “the” include plural referents unless the content clearly dictates otherwise. As used herein, the term “about” refers to the recited number and any value within 10% of the recited number. Thus, “about 5” refers to any value between 4.5 and 5.5, including 4.5 and 5.5.

### II. SYSTEMS

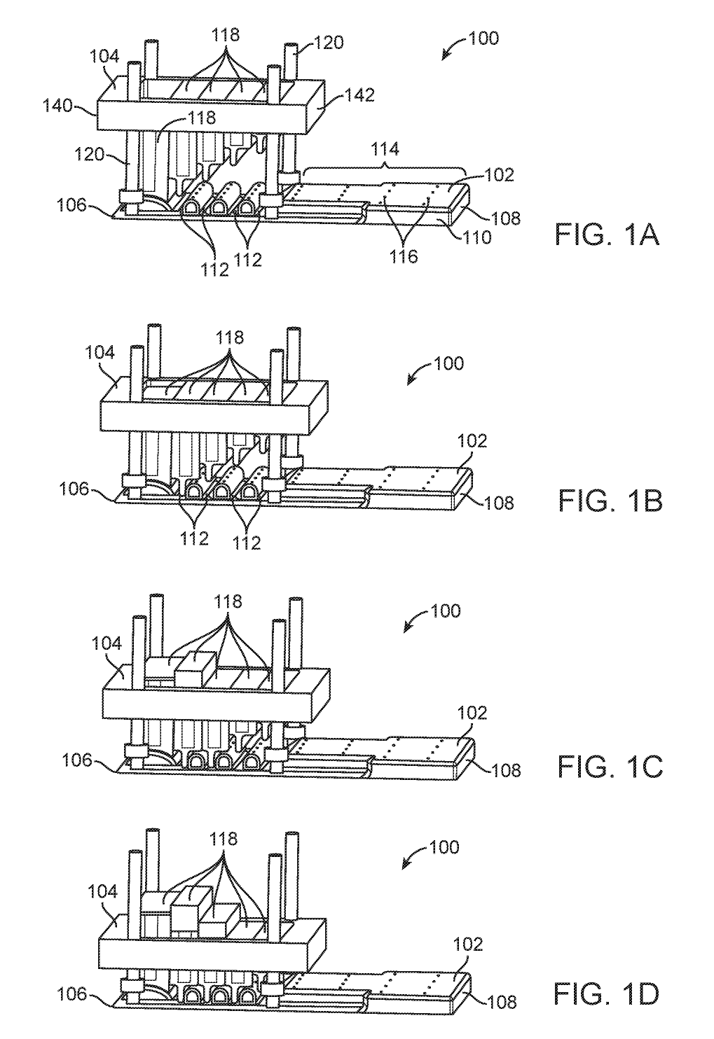

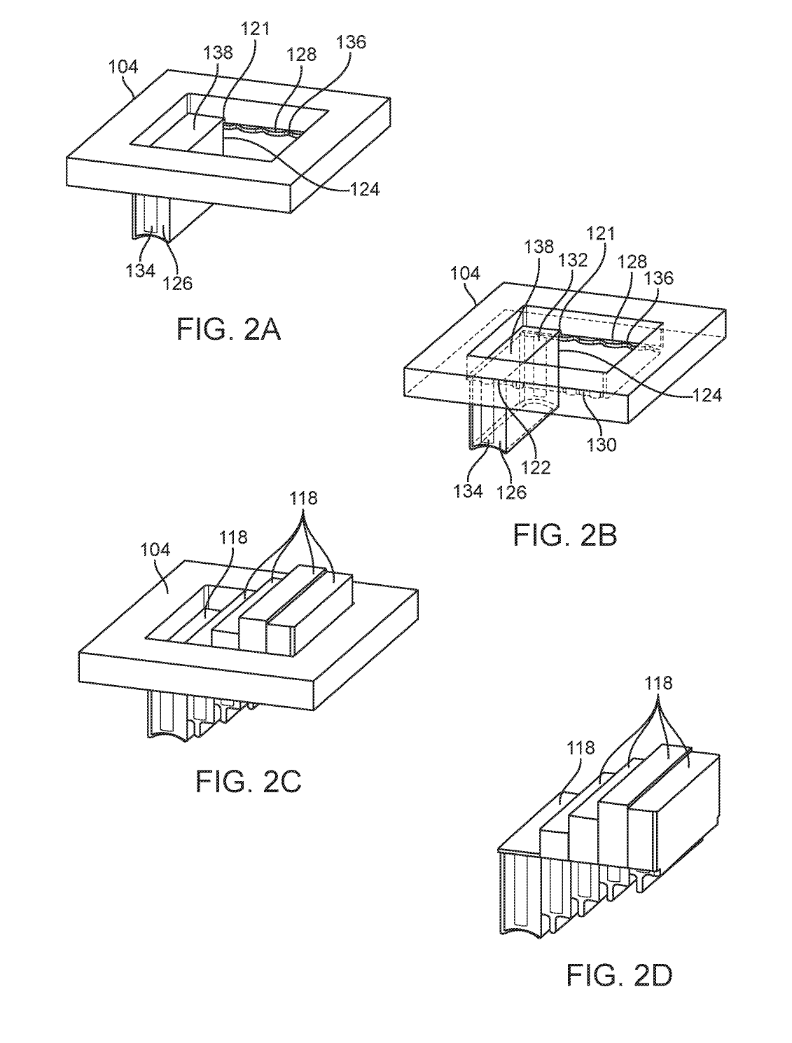

FIGS. 1A-2D illustrate an embodiment of a molding system 100. The molding system 100 comprises a mold 102, a frame 104, and a vacuum source. The mold 102 comprises a first end 106, a second end 108, and two lateral sides 110. The mold 102 further comprises a plurality of depressions 112 on about a first half of the mold 102, a planar region 114 on about a second half of the mold 102, and a plurality of through-holes 116 for applying a vacuum to the mold 102. The plurality of through-holes 116 runs from an upper surface to a lower surface of the mold 102. The frame 104 comprises a plurality of vertically movable presses 118. In some embodiments, the frame 104 comprises a plurality of legs 120 to support the frame 104 and presses 118.

A first overhang 121 and a second overhang 122 project over a first side 124 and a second side 126, respectively, of each press 118. The first overhang 121 rests on a first inner ledge 128 and the second overhang 122 rests on a second inner ledge 130 of the frame 104. A first guide 132 and a second guide 134 are located on the first side 124 and second side 126, respectively, of each press 118. The first and second guides 132, 134 run up and down the sides and guide the vertical movement of the press 118. Each guide can move through an indentation 136 in the ledge that matches the shape of the guide. In certain embodiments, a first press 138 rests on a ridge of the mold 102 and each subsequent press sequentially fits into a different depression in the mold 102. In some embodiments, each press sequentially fits into a different depression in the mold 102. In some embodiments, the end of the press that fits into a depression is tapered to match the shape of the depression. In certain embodiments, each press has a width spanning the longest dimension of each of the depressions in the mold 102. In an embodiment, each press is a heavy metal (e.g., steel) plate. In some embodiments, the distance of each press from the mold 102 increases from a first end 140 of the frame 104 to a second end 142 of the frame 104. In some embodiments, each press is operable by gravity. In certain embodiments, each press is motor driven. The presses can have different shapes. For example, the presses can be rods or fingers that sequentially are moved into the depressions by a motor in an angular or vertical direction.

The vacuum source is operatively connected to each of the through-holes 116 in the mold 102. In some embodiments, the system 100 further comprises a second vacuum source. In some embodiments, the vacuum source(s) is/are a vacuum pump.

In some embodiments, each of the depressions 112 in the mold 102 has a longest dimension perpendicular to a lateral side of the mold 102. In certain embodiments, the plurality of depressions 112 is at least two depressions.

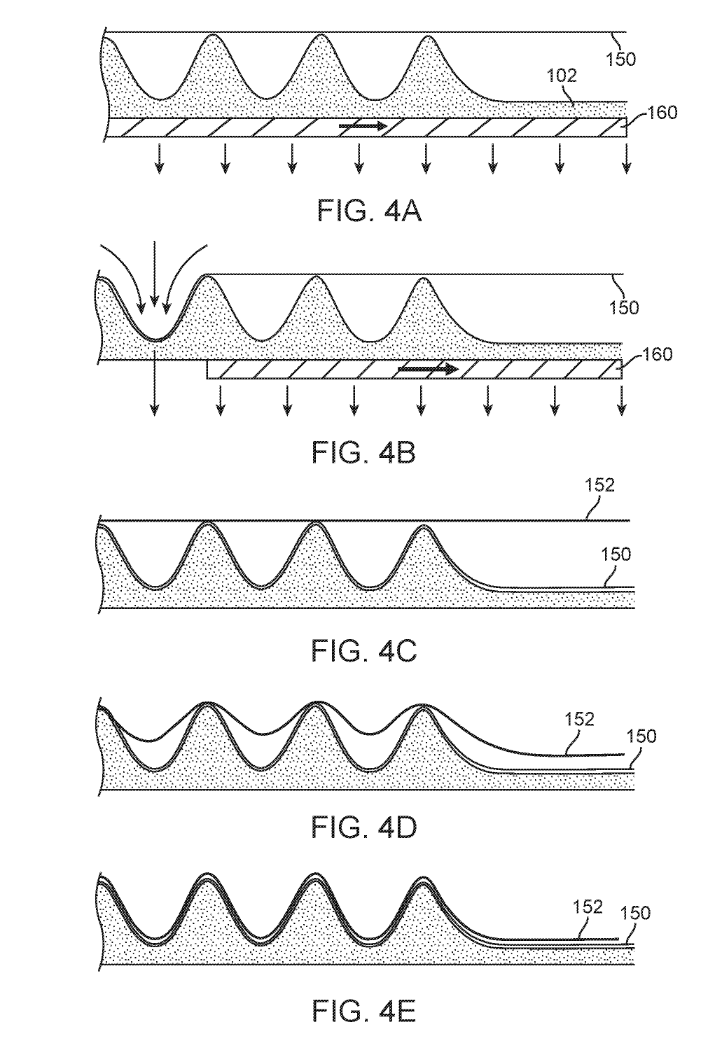

Referring again to FIGS. 1 and 4A-4B, the depressions 112 can be any size and shape. In some embodiments, each of the depressions 112 comprises a length L1, a width W1, and a depth D1. In some embodiments, each of the depressions 112 is at least about 0.1, 0.5, 1.0, 8.5, 13.5, 20 cm or more in at least one dimension. In some cases, the length L1 and the width W1 of each of the depressions 112 are at least about 2-fold, 3-fold, 5-fold, 10-fold, 100-fold or more larger than the depth D1. In some embodiments, each of the depressions 112 is sized to match the width of the first sheet and/or a second sheet and has a length L1 that is at least about 3-fold, 4-fold, 5-fold, 6-fold, 8-fold, 10-fold, 13-fold, 17-fold, 20-fold, 27-fold or more larger than the width W1. Exemplary sizes of each depression 112 include, but are not limited to, about 0.5 cm×8.5 cm, 1×3 cm, 3 cm×3 cm, 2.5 cm×about 8.5 cm, 1 cm×10 cm, 3 cm×10 cm, 2 cm×13.5 cm, 3×13.5 cm, 1 cm×15 cm, 3 cm×15 cm, or 3.5 cm×20 cm in width W1 and length L1, respectively. As used herein, the “width W1” is the shortest dimension. In some embodiments, each depression 112 is 3 cm in width W1 by 10 cm in length L1. In some cases, each depression 112 is 1±0.5, 1, 2 or 3 cm in width W1 by 10±0.5 cm or 15±0.5 cm in length L1. In some cases, the depth D1 of at least one depression 112 is about 0.5 cm, about 1 cm, about 2 cm, or about 3 cm.

### III. METHODS

Provided are methods of co-molding and thermobonding a first sheet 150 to a second sheet 152 using the devices described herein.

The first and second sheets 150, 152 each have a width, a length, and a height (e.g., a thickness). In some cases, the length and the width of the first and second sheets 150, 152 are at least about 2-fold, 5-fold, 10-fold, 100-fold or more larger than the height (i.e., thickness). In some embodiments, the second sheet 152 is larger in at least one dimension than the first sheet 150. In certain embodiments, a surface area of the first sheet 150 is not capable of increasing or decreasing (i.e., the first sheet 150 cannot stretch or shrink in any dimension). In some cases, the first sheet 150 can tear or rip if stretched in any dimension. In some embodiments, a surface area of the second sheet 152 is capable of increasing or decreasing (i.e., the second sheet 152 can stretch or shrink in any dimension). In an embodiment, the surface area of the second sheet 152 can be increased by heating the second sheet 152.

Exemplary sizes for the first and second sheets 150, 152 include, without limitation, first and second sheets 150, 152 that are at least about 0.25 cm, 0.5 cm, 1 cm, 2 cm, 3 cm, 4 cm, 5 cm, 6 cm, 7 cm, 8 cm, 10 cm, 12 cm, 15 cm, 20 cm, 25 cm, 30 cm or more in at least one dimension. In some cases, the first and second sheets 150, 152 are 20±0.5, 1, 2, 3, 4, 5, 6, 9 or 10 cm in length by 10±0.5, 1, 2, 3, 4, 5, 6, 7, 8, or 9 cm in width. In some cases, the second sheet is larger than the first sheet, e.g., 2×, 3×, 4×, 5× or more larger.

The first sheet 150 is an absorbent material. In some embodiments, the first sheet 150 is configured to have a high solution capacity and a lateral flow rate. In some cases, the high solution capacity and lateral flow rate are provided by having a first sheet 150 with substantial height (e.g., thickness). In some cases, the first sheet 150 is about 10, 9, 8, 7, 6, 5, 4, 3, 2, 1, 0.75, 0.5, or about 0.2 mm thick. In some cases, the first sheet 150 is between about 0.05 mm and about 0.5 mm thick.

The first sheet 150 generally has a large surface area due to the presence of a plurality of pores (i.e., the first sheet is porous). The large surface area can increase the loading capacity of the first sheet 150 for one or more reagents or one or more solutions containing a reagent. In some embodiments, the first sheet 150 has a specific surface area of at least about 0.001 m²/g, 0.02 m²/g, 0.1 m²/g, 0.5 m²/g, 1 m²/g, 10 m²/g, or more as measured by standard techniques.

In some embodiments, the first sheet 150 can have a particular pore size, a particular average pore size, or a particular pore size range. For example, the first sheet 150 can contain 0.1 μm pores, 0.2 μm pores, 0.45 μm pores, or 1, 2, 4, 5, 6, 7, 8, 10, 15, 20 μm pores, or pores larger than about 20 μm. As another example, the first sheet 150 can contain pores that average 0.1, 0.2, 0.45, 1, 2, 4, 5, 6, 7, 8, 10, 15, or 20 μm, or more in size. As another example, the first sheet 150 can contain pores that range about 0.1-8 μm, 0.2-8 μm, 0.45-8 μm, 1-8 μm, 0.1-4 μm, 0.1-2 μm, 0.1-1 μm, 0.1-0.45 μm, 0.2-8 μm, 0.2-4 μm, 0.2-2 μm, 0.2-1 μm, 0.2-0.45 μm, 0.45-8 μm, 0.45-4 μm, 0.45-2 μm, 0.45-1 μm in size. In some cases, the first sheet 150 can contain pores that are less than about 20 μm in size. For example, the first sheet 150 can be composed of a material in which at least about 50%, 60%, 70%, 80%, 90% or more of the pores are less than about 20, 15, 10, or 5 μm in size. In some cases, the pores can be at least 1 nm in size, at least 5 nm in size, at least 10, 100, or 500 nm in size. Alternatively, at least 50%, 60%, 70%, 80%, 90% or more of the pores can be more than 1, 5, 10, 50, 100, or 500 nm in size. As used herein, pore size can be measured as a radius or a diameter. In some cases, the first sheet 150 contains porous polyethylene, such as porous polyethylene having a pore size between 0.2 and 20 microns, or between 1 and 12 microns. The first sheet 150 can have a different pore size in different regions of the pad. For example, the first sheet 150 can have a lateral flow region that has a different pore size or pore size range. In some embodiments, pore size is chosen to control flow rate. For example, a larger pore size will allow for a faster flow rate. In some cases, the wicking pad (e.g, glass fiber or cellulose) contains voids which can be defined by the size of particles retained by the material and/or flow rate (e.g., time it takes for water to flow 4 centimeters).

The first sheet 150 is generally formed of a bibulous material and can be made out of, for example, natural fibers, synthetic fibers, glass fibers or blends thereof. Non-limiting examples include cotton, glass, and combinations thereof. There are many commercial materials available for diagnostic uses from vendors including, but not limited to, Ahlstrom, GE, PALL, Millipore, Sartorius, and S&S.

The bibulous material can include, but is not limited to, polymer containing material. The polymer can be in the form of polymer beads, a polymer membrane, or a polymer monolith. In some cases, the polymer is cellulose. Cellulose containing pads include paper, cloth, woven, or non-woven cellulose substrates. Cloth pads include those containing a natural cellulose fiber such as cotton or wool. Paper pads include those containing natural cellulose fiber (e.g., cellulose or regenerated cellulose) and those containing cellulose fiber derivatives including, but not limited to cellulose esters (e.g., nitrocellulose, cellulose acetate, cellulose triacetate, cellulose proprionate, cellulose acetate propionate, cellulose acetate butyrate, and cellulose sulfate) and cellulose ethers (e.g., methylcellulose, ethylcellulose, ethyl methyl cellulose, hydroxyethyl cellulose, hydroxyethyl methyl cellulose, hydroxypropyl methyl cellulose, ethyl hydroxyethyl cellulose, and carboxymethyl cellulose). In some cases, the cellulose pads contains rayon. In some cases, the pad is paper, such as a variety of WHATMAN® paper.

The bibulous material can also include, but is not limited to, a sintered material. For example, the bibulous material can contain a sintered glass, a sintered polymer, or sintered metal, or a combination thereof. In some cases, the sintered material is formed by sintering one or more of powdered glass, powdered polymer, or powdered metal. In other cases, the sintered material is formed by sintering one or more of glass, metal, or polymer fibers. In still other cases, the sintered material is formed from the sintering of one or more of glass, polymer, or metal beads.

The bibulous material can also contain, but is not limited to, one or more non-cellulosic polymers, e.g. a synthetic polymer, a natural polymer, or a semisynthetic polymer. For example, the material can contain a polyester, such as polyglycolide, polylactic acid, polycaprolactone, polyethylene adipate, polyhydroxylalkanoate, polyhydroxybutyrate, poly(3-hydroxybutyrate-co-3-hydroxyvalerate, polyethylene terephthalate, polybutylene terephthalate, polytrimethylene terephthalate, polyethylene naphthalate, Vectran®. In some cases, the polymer is spunbound, such as a spunbound polyester.

Additional synthetic polymers include, but are not limited to nylon, polypropylene, polyethylene, polystyrene, divinylbenzene, polyvinyl, polyvinyl difluoride, high density polyvinyl difluoride, polyacrylamide, a (C₂-C₆) monoolefin polymer, a vinylaromatic polymer, a vinylaminoaromatic polymer, a vinylhalide polymer, a (C₁-C₆) alkyl (meth)acrylate polymer, a(meth)acrylamide polymer, a vinyl pyrrolidone polymer , a vinyl pyridine polymer, a (C₁-C₆) hydroxyalkyl (meth)acrylate polymer, a (meth)acrylic acid polymer, an acrylamidomethylpropylsulfonic acid polymer, an N-hydroxy-containing (C₁-C₆) alkyl(meth)acrylamide polymer, acrylonitrile or a mixture of any of the foregoing.

The second sheet 152 is not porous and is formed from one or more thermoplastics including, but not limited to, polyethylene terephthalate, polyethylene terephthalate glycol modified, polypropylene, polystyrene, and/or polycarbonate.

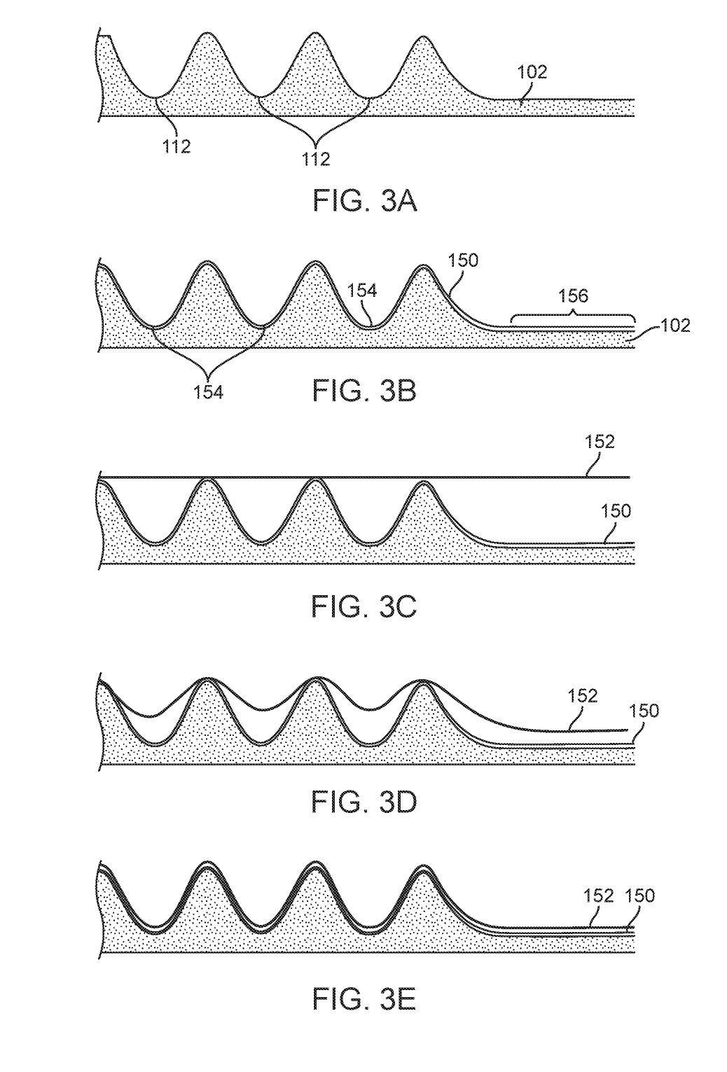

In an embodiment, the method of co-molding and thermobonding a first sheet to a second sheet comprises sequentially press-fitting the first sheet 150 onto a mold 102 to form a shaped first sheet, wherein the mold 102 comprises a plurality of through-holes for applying a vacuum to the mold 102. The first sheet 150 is sequentially press-fitted into the mold 102 to prevent tears in the first sheet. In some embodiments, the first sheet 150 is sequentially press-fitted into a plurality of depressions 112 in the mold. In certain embodiments, a first press 138 anchors the first sheet 150 to a surface of the mold 102 and then each subsequent press sequentially press-fits the rest of the first sheet 150 onto the mold 102 (e.g., into the plurality of depressions 112) to form the shaped first sheet (FIGS. 1A-1D and FIGS. 3A-3B).

In some embodiments, the shaped first sheet comprises a plurality of depressions 154. In certain embodiments, the shaped first sheet further comprises a planar region 156. In some embodiments, the plurality of depressions 154 is at least two depressions. In certain embodiments, the plurality of depressions 154 is on about a first half of the shaped first sheet. In some embodiments, each depression has a longest dimension perpendicular to a lateral edge of the shaped first sheet. In certain embodiments, a cross-section of each of the depressions has a “V” shape, a semicircle shape, an oval shape, a “U” shape, a rectangle shape, a square shape, or a trapezoid shape.

The next step of the method comprises applying a vacuum (e.g., with a first vacuum pump) to the mold 102 to hold the shaped first sheet to the mold 102. A second sheet 152 that is heated to a molding and thermobonding temperature is then applied to the shaped first sheet (FIGS. 3C-3D). In some embodiments, the molding and thermobonding temperature is at least a glass transition temperature. The heated second sheet 152 is then pulled tight to the shaped first sheet with the vacuum to co-mold and thermobond the second sheet 152 to the shaped first sheet (FIG. 3E). In some embodiments, the first vacuum pump is used to pull the heated second sheet 152 tight to the shaped first sheet. In some embodiments, a second vacuum pump is used to pull the heated second sheet 152 tight to the shaped first sheet. In some embodiments, the heated second sheet is simultaneously applied and pulled tight to the shaped first sheet to co-mold and thermobond the second sheet to the shaped first sheet. In certain embodiments, the resultant co-molded and thermobonded first and second sheets are removed from the mold 102 after the sheets have cooled on the mold 102. Cooling of the molded sheets helps to maintain the molded shape and prevent cracking, tears or wrinkling of the first sheet in cases where the second sheet contracts upon cooling.

In some embodiments, the method of co-molding and thermobonding a first sheet 150 to a second sheet 152 comprises sequentially applying a vacuum (e.g., with a first vacuum pump) to the first sheet 150 to sequentially pull the first sheet 150 tight to a mold 102 to form a shaped first sheet (FIGS. 4A-4B), wherein the mold comprises a plurality of through-holes for applying a vacuum to the mold 102; applying a second sheet 152 heated to a molding and bonding temperature to the shaped first sheet (FIG. 4C); pulling the heated second sheet tight to the shaped first sheet with the vacuum (e.g., with the first pump or a second vacuum pump) to co-mold and thermobond the second sheet to the shaped first sheet (FIGS. 4D-4E). In certain embodiments, the sequentially applying a vacuum to the first sheet step comprises sequentially pulling the first sheet into a plurality of depressions in the mold. In some embodiments, the vacuum is applied sequentially to the first sheet by sequentially uncovering the through-holes in the mold (FIG. 4B). In certain embodiments, the through-holes are covered by a movable planar cover 160 having a similar width and length as the mold 102.

All patents, patent applications, and other published reference materials cited in this specification are hereby incorporated herein by reference in their entirety.

What is claimed is:

1. A molding system comprising:
a mold having a first end, a second end and two lateral sides, the mold comprising:
a plurality of depressions;
a planar region; and
a plurality of through-holes for applying a vacuum to the mold, the through-holes running from an upper surface to a lower surface of the mold;
a frame having a plurality of vertically movable presses; and
a vacuum source operatively connected to each of the through-holes in the mold.

2. The system of claim 1, wherein the plurality of depression are on about a first half of the mold.

3. The system of claim 1 or 2, wherein the planar region is on about a second half of the mold.

4. The system of claim 1, wherein each press sequentially fits into a different depression in the mold.

5. The system of claim 1, wherein a first press rests on a ridge of the mold and each subsequent press sequentially fits into a different depression in the mold.

6. The system of claim 1, wherein each of the depressions has a longest dimension perpendicular to a lateral side of the mold.

7. The system of claim 1, wherein each press has a width spanning the longest dimension of each of the depressions in the mold.

8. The system of claim 1, wherein the distance of each press from the mold increases from a first end of the frame to a second end of the frame.

9. The system of claim 1, wherein each press is operable by gravity.

10. The system of claim 1, wherein the plurality of depressions is at least two depressions.

11. The system of any of claims 1, further comprising a second vacuum source.

12. A method of co-molding and thermobonding a first sheet to a second sheet, the method comprising:
sequentially press-fitting the first sheet onto a mold to form a shaped first sheet, wherein the mold comprises a plurality of through-holes for applying a vacuum to the mold;
applying a vacuum to the mold to hold the shaped first sheet to the mold;
applying a second sheet heated to a molding and bonding temperature to the shaped first sheet;
pulling the heated second sheet tight to the shaped first sheet with the vacuum to co-mold and thermobond the second sheet to the shaped first sheet.

13. The method of claim 12, wherein the first sheet is sequentially press-fitted into a plurality of depressions in the mold.

14. The method of claim 12, further comprising anchoring the first sheet onto the mold prior to sequentially press-fitting the first sheet onto the mold.

15. The method of claim 12, wherein a surface area of the first sheet is not capable of increasing or decreasing.

16. The method of claim 12, wherein a surface area of the second sheet is capable of increasing or decreasing.

17. The method of claim 16, wherein the surface area of the second sheet is increased by heating the second sheet.

18. The method of claim 12, wherein the molding and bonding temperature is at least a glass transition temperature.

19. The method of claim 12, wherein the first sheet is formed of at least one material selected from the group consisting of glass fiber, cellulose, and polymeric material.

20. The method of claim 12, wherein the second sheet is formed of a thermoplastic.
